(19) United States
(12) Patent Application Publication
(10) Pub. No.: US 2024/0199095 A1
(43) Pub. Date: Jun. 20, 2024

(54) ABNORMALITY DETECTION DEVICE, ABNORMALITY DETECTION METHOD, AND STORAGE MEDIUM

(71) Applicant: NEC Corporation, Minato-ku, Tokyo (JP)

(72) Inventors: Yuko Ohta, Tokyo (JP); Reishi Kondo, Tokyo (JP); Sakiko Mishima, Tokyo (JP); Yumi Arai, Tokyo (JP)

(73) Assignee: NEC Corporation, Minato-ku, Tokyo (JP)

(21) Appl. No.: 18/288,070

(22) PCT Filed: May 7, 2021
(86) PCT No.: PCT/JP2021/017460

§ 371 Date: Oct. 24, 2023

(51) Int. Cl. B61K 9/08; B61L 23/04; G01N 29/44

(52) U.S. Cl. CPC B61K 9/08; B61L 23/042; G01N 29/4445

(57) ABSTRACT

A data collection device according to an aspect of the present disclosure includes: at least one memory storing a set of instructions; and at least one processor configured to execute the set of instructions to: detect a target data point that is a data point at which a target is observed in acoustic data obtained by observation of the target; determine an analysis range in the acoustic data based on the target data point; detect an abnormality in the analysis range; and output information of the analysis range in which the abnormality is detected.

### TECHNICAL FIELD

The present disclosure relates to a technique for detecting an abnormality.

### BACKGROUND ART

Periodic inspection of railway equipment is mandated by the Ministry of Land, Infrastructure, Transport and Tourism, and railway companies conduct patrol according to the type of the owned railway and the type of equipment. A technique for monitoring an abnormality during operation using an advanced technique is being developed. In particular, a bolt loosening at a joint of a rail or loosening of a hook bolt of a bridge may not be found until the loosened bolt is broken, and an abnormality identification system that assists patrol or periodic inspection is required.

An example of a technique for estimating a state of a rail joint is disclosed in the following document.
PTL 1 and Cited Document 4 disclose a method for estimating the stress applied to the joint plate from the measured own axle box acceleration and the height deviation based on the relationship between the axle box acceleration applied to the axle box of the vehicle, the height deviation of the rail at the traveling point of the vehicle, and the stress applied to the joint plate of the adhesive insulating rail.
PTL 2 discloses a device that measures a size of a free space formed in a rail joint portion using a gauge.
PTL 3 discloses a method of performing Fourier transform on an acoustic signal acquired in a vehicle traveling on a track and detecting an activation state based on a peak value at predetermined time intervals.
PTL 5 discloses a device that determines an abnormality of an axle bearing of a target using vibration data of the target when a distance between a reference point of the target traveling along a track and the track is within a predetermined range.
PTL 6 discloses an abnormality detection device that calculates a signal pattern feature related to an acoustic signal of an abnormality detection target and calculates an abnormality score for performing abnormality detection based on the signal pattern feature. The signal pattern feature related to the acoustic signal of the abnormality detection target is calculated based on the signal pattern model learned based on the acoustic signal of the first time width and the long-time feature amount calculated from the acoustic signal of the second time width longer than the first time width.

### CITATION LIST

### Patent Literature

PTL 1: JP 5128870 B2
PTL 2: JP 6-074912 A
PTL 3: JP 2007-145270 A
PTL 4: JP 2009-042054 A
PTL 5: JP 2018-081003 A
PTL 6: WO 2019/220620 A1

### SUMMARY OF INVENTION

### Technical Problem

Abnormalities such as bolt loosening of a rail joint may appear as a sound when a train passes. This is an empirically known event for drivers and the like. In order to learn a model that accurately detects an abnormality using sound, it is necessary to collect sound when a train passes through a rail joint where an abnormality such as bolt loosening occurs.

PTLs 1 to 6 describe techniques for detecting an abnormality. In the techniques of PTLs 1 to 6, it is not possible to efficiently collect acoustic data obtained from a target in which an abnormality has occurred.

One object of the present disclosure is to provide a data collection device and the like that can improve the efficiency of collection of acoustic data obtained from a target in which an abnormality has occurred.

### Solution to Problem

A data collection device according to an aspect of the present disclosure includes a target detection means configured to detect a target data point which is a data point at which a target is observed in acoustic data obtained by observation of the target, a determination means configured to determine an analysis range in the acoustic data based on the target data point, an abnormality detection means configured to detect an abnormality in the analysis range, and an output means configured to output information of the analysis range in which the abnormality is detected.

A data collection method according to an aspect of the present disclosure includes detecting a target data point that is a data point at which a target is observed in acoustic data obtained by observation of the target, determining an analysis range in the acoustic data based on the target data point, detecting an abnormality in the analysis range, and outputting information of the analysis range in which the abnormality is detected.

A program according to an aspect of the present disclosure causes a computer to execute detecting a target data point which is a data point at which a target is observed in acoustic data obtained by observation of the target, determining an analysis range in the acoustic data based on the target data point, detecting an abnormality in the analysis range, and outputting information of the analysis range in which the abnormality is detected. One aspect of the present disclosure is also achieved by a storage medium that stores the above-described program.

### Advantageous Effects of Invention

The present disclosure has an effect of efficiently collecting acoustic data obtained from a target in which an abnormality has occurred.

### BRIEF DESCRIPTION OF DRAWINGS

FIG. 1 is a block diagram illustrating an example of a configuration of a data collection device according to a first example embodiment of the present disclosure.

FIG. 2 is a flowchart illustrating an example of operation of a data collection device 100 according to the first example embodiment of the present disclosure.

FIG. 3 is a block diagram illustrating an example of a configuration of a data collection device 101 according to a second example embodiment of the present disclosure.

FIG. 4 is a flowchart illustrating an example of operation of the data collection device 101 according to the second example embodiment of the present disclosure.

FIG. 5 is a block diagram illustrating an example of a configuration of a data collection device 101A according to a first modification of the second example embodiment.

FIG. 6 is a block diagram illustrating an example of a configuration of a data collection device 101B according to a second modification of the second example embodiment.

FIG. 7 is a block diagram illustrating an example of a configuration of a data collection device 101C according to a third modification of the second example embodiment.

FIG. 8 is a block diagram illustrating an example of a configuration of a data collection device 101D according to a fifth modification of the second example embodiment of the present disclosure.

FIG. 9 is a flowchart illustrating an example of an operation of assigning target reliability of the data collection device 101D according to the fifth modification of the second example embodiment of the present disclosure.

FIG. 10 is a block diagram illustrating an example of a configuration of a data collection device 101E according to a seventh modification of the second example embodiment of the present disclosure.

FIG. 11 is a flowchart illustrating an example of an operation of the data collection device 101E according to the seventh example embodiment of the present disclosure.

FIG. 12 is a block diagram illustrating an example of a configuration of a data collection device 101F according to an eighth modification of the second example embodiment of the present disclosure.

FIG. 13 is a diagram illustrating an example of a hardware configuration of a computer 1000 that can implement each of the data collection devices according to the example embodiments of the present disclosure.

### EXAMPLE EMBODIMENT

Hereinafter, example embodiments of the present disclosure will be described in detail with reference to the drawings.

### First Example Embodiment

Hereinafter, a first example embodiment of the present disclosure will be described.

### <Configuration>

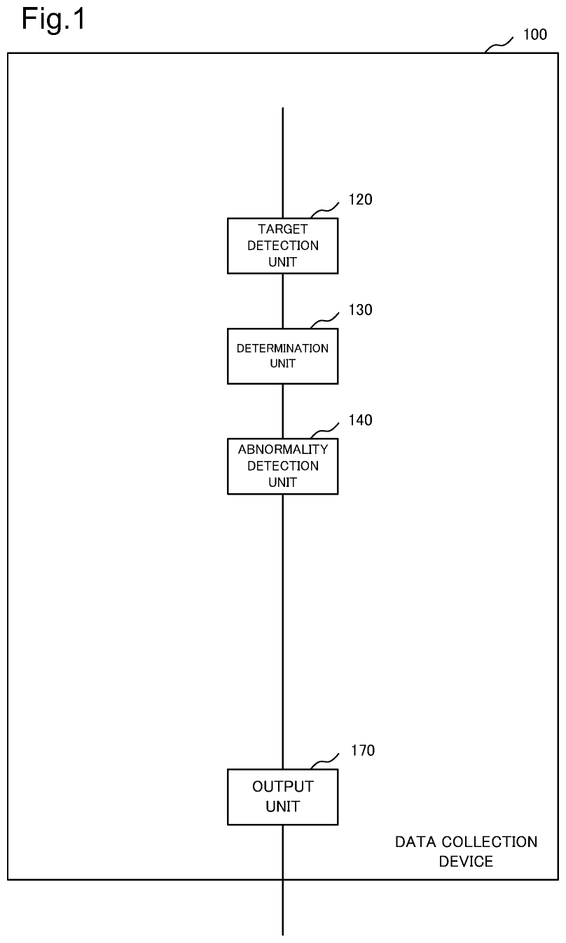

FIG. 1 is a block diagram illustrating an example of a configuration of a data collection device according to the first example embodiment of the present disclosure.

### <Data Collection Device 100>

In the example illustrated in FIG. 1, a data collection device 100 includes a target detection unit 120, a determination unit 130, an abnormality detection unit 140, and an output unit 170. The target detection unit 120 detects target data points that are data points at which a target is observed in acoustic data obtained by observation of the target. The determination unit 130 determines an analysis range in the acoustic data based on the target data point. The determination unit 130 detects an abnormality in the analysis range. The output unit 170 outputs information of the analysis range in which the abnormality is detected. Hereinafter, data obtained by observation will be described as vibration data, but the data obtained by observation may be vibration data instead of acoustic data.

### <Target Detection Unit 120>

The acoustic data is, for example, time-series data representing a transition of an acoustic sound obtained by converting data observed by a sensor attached to a vehicle or the like traveling on a railway track into data in a frequency domain. The sensor is, for example, an acoustic sensor such as a microphone or a sensor capable of observing sound or vibration generated when the vehicle passes through a rail joint, such as a vibration sensor. Hereinafter, the sensor will be described as an acoustic sensor. The position where the sensor is attached may be, for example, a portion below the vehicle, such as near a carriage or a rail of the vehicle. The position where the sensor is mounted may be a portion of the vehicle placed on the carriage. The position where the sensor is mounted may be a surface of a carriage or a vehicle. The position where the sensor is mounted may be inside the carriage or the vehicle. Hereinafter, the data at each time point included in the acoustic data is referred to as element data. The method of conversion may be any of various existing methods. The target is, for example, a rail joint. The target data point is, for example, data observed when a wheel having the shortest distance from the sensor passes through a rail joint. For example, the target detection unit 120 detects a point at which the sound pressure takes a maximum value of a magnitude equal to or larger than a threshold in the acoustic data as a target data point.

The acoustic data may be associated with the observation time. For example, a time interval of individual element data of the acoustic data and a start time of observation of the acoustic data are given. Each element data of the acoustic data may be associated with the observation time. Furthermore, the traveling speed of the vehicle at the time of observation and the length of the rail may be obtained. For example, the target detection unit 120 may detect a point at which the sound pressure takes a maximum value having a magnitude equal to or larger than a threshold in the acoustic data as the target data point. In this case, the target detection unit 120 may further calculate the time at which the next target data point is obtained based on the time at which the detected target data point is observed, the traveling speed of the vehicle, and the length of the rail. Then, the target detection unit 120 may detect data observed at the calculated time as a target data point. The target detection unit 120 may detect, as a target data point, a point at which the sound pressure has a maximum value of a magnitude equal to or larger than a threshold from data observed during a predetermined time width including the calculated time.

Furthermore, for example, an observation location obtained using a global positioning system (GPS) or the like may be associated with the observation time. The target detection unit 120 may estimate the time at which the vehicle has passed through the rail joint in the period in which the observation data is obtained, using the relationship between the observation location and the observation time. The target detection unit 120 may detect data observed at the estimated time as a target data point. The target detection unit 120 may detect, as a target data point, a point at which the sound pressure has a maximum value of a magnitude equal to or larger than a threshold from data observed during a predetermined time width including the estimated time.

### <Determination Unit 130>

For example, the determination unit 130 may determine, as the analysis range, data obtained in a period from a time a predetermined time (denoted as a first predetermined time) before a time at which the target data point is observed to a time a predetermined time (second predetermined time) after the time at which the target data point is observed. The first predetermined time and the second predetermined time may be the same. The first predetermined time and the second predetermined time may be fixed. The first predetermined time and the second predetermined time may be determined based on the traveling speed of the vehicle at the time when the target data point is observed. Specifically, the first predetermined time and the second predetermined time may be set to be shorter as the traveling speed of the vehicle is higher. In the following description, a range of observation data from a time that is the first predetermined time before the time at which the target data point is observed to a time that is the second predetermined time after the time at which the target data point is observed is referred to as an influence range. The start time of the influence range is referred to as an influence start time. The end time of the influence range is referred to as an influence end time. In other words, the influence range is a part of the acoustic data observed from the influence start time to the influence end time. The determination unit 130 may determine the influence range as the analysis range.

The determination unit 130 may determine, as the analysis range, a range that includes the target data points and excludes a range having a length shorter than the length of the influence range (denoted as an exclusion range) in the influence range. In the following description, the start time of the exclusion range is referred to as an exclusion start time. The end time of the exclusion range is referred to as an exclusion end time. The exclusion start time is determined to be later than the influence start time. The exclusion end time is determined to be earlier than the influence end time. The time from the exclusion start time to the time at which the target data point is observed is referred to as a third predetermined time. The time from the time when the target data point has been observed to the exclusion end time is referred to as a fourth predetermined time. The third predetermined time and the fourth predetermined time may be fixed. The third predetermined time and the fourth predetermined time may be determined based on the traveling speed of the vehicle at the time when the target data point is observed. Specifically, the third predetermined time and the fourth predetermined time may be set to be shorter as the traveling speed of the vehicle is higher. In other words, the determination unit 130 determines, as the analysis range, a range obtained by excluding the exclusion range from the influence range. In other words, the determination unit 130 determines, as the analysis range, the range of the acoustic data observed from the influence start time to the exclusion start time and the range of the acoustic data observed from the exclusion end time to the influence end time.

### <Abnormality Detection Unit 140>

The abnormality detection unit 140 detects an abnormality in the analysis range. Specifically, the abnormality detection unit 140 detects, for example, an abnormality pattern that occurs when an abnormality exists in the rail joint in the analysis range. The abnormality pattern may be, for example, a peak of intensity that exists between 10 to 20 Hz. The abnormality pattern may be a peak of intensity that exists between 10 Hz and 20 Hz and is attributed to hair for a predetermined time or more. The abnormality pattern may be, for example, a pattern obtained by learning in advance.

When an abnormality pattern is detected in the analysis range, the abnormality detection unit 140 determines that an abnormality is detected in the rail joint. When an abnormality pattern is detected in the analysis range, the abnormality detection unit 140 may extract a characteristic of the detected abnormality pattern. The characteristic of the abnormality pattern may, for example, be the duration of the peak of intensity, present between 10 Hz and 20 Hz, in the analysis range. The characteristic of the abnormality pattern may be, for example, the duration of the peak of intensity between 10 Hz and 20 Hz before the time when the target data point is observed and the duration of the peak of intensity between 10 Hz and 20 Hz after the time when the target data point is observed in the analysis range. The characteristic of the abnormality pattern is not limited to these examples.

The abnormality detection unit 140 may detect the abnormality of the rail joint by, for example, a detector that detects the abnormality of the rail joint obtained by learning in advance.

### <Output Unit 170>

The output unit 170 outputs information of the analysis range in which the abnormality is detected. The information of the analysis range in which the abnormality is detected is, for example, acoustic data in the analysis range. The information of the analysis range in which the abnormality is detected is, for example, acoustic data in the analysis range and a characteristic of the detected abnormality.

The output unit 170 may output the information of the analysis range in which the abnormality is detected to the display of the data collection device 100. The output unit 170 may store the information of the analysis range in which the abnormality is detected in the storage device. The storage device may be an external storage device, a server, or the like connected to the data collection device 100. The storage device may be a storage device attached inside the data collection device 100. The storage device may be a storage medium that can be read and written by the data collection device 100.

### <Operation>

Next, an operation of the data collection device 100 according to the first example embodiment of the present disclosure will be described in detail with reference to the drawings.

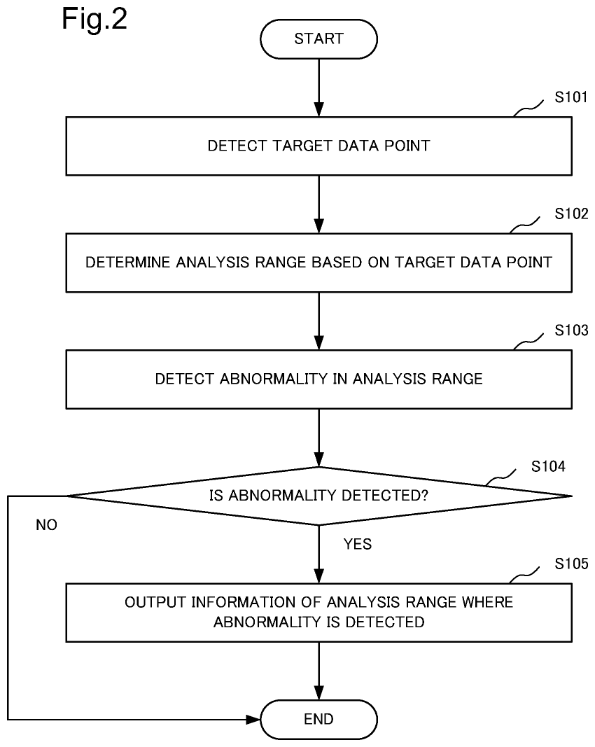

FIG. 2 is a flowchart illustrating an example of the operation of the data collection device 100 according to the first example embodiment of the present disclosure.

In the example illustrated in FIG. 2, first, the target detection unit 120 detects a target data point in the acoustic data (step S101). The target detection unit 120 may detect one or more target data points existing in the acoustic data. The target detection unit 120 may detect all target data points existing in the acoustic data.

Next, the determination unit 130 determines an analysis range based on the target data points in the acoustic data (step S102). The determination unit 130 may determine the analysis range for each of the target data points detected in step S101.

Next, the abnormality detection unit 140 detects an abnormality in the determined analysis range (step S103). The abnormality detection unit 140 may detect an abnormality in each of the analysis ranges determined in step S102.

When no abnormality is detected (NO in step S104), the data collection device 100 ends the operation illustrated in FIG. 2. In this case, before the data collection device 100 ends the operation illustrated in FIG. 2, the output unit 170 may output information indicating that no abnormality has been detected in the acoustic data.

When an abnormality is detected (YES in step S104), the output unit 170 outputs information of the analysis range in which the abnormality is detected. The output unit 170 may output information of the analysis range in which the abnormality is detected for each of the analysis ranges in which the abnormality is detected.

### <Effects>

The present disclosure has an effect of efficiently collecting acoustic data obtained from a target in which an abnormality has occurred. This is because the target detection unit 120 detects a target data point, the determination unit 130 determines an analysis range based on the target data point, and the abnormality detection unit 140 detects an abnormality in the determined analysis range.

### Second Example Embodiment

Next, a second example embodiment of the present disclosure will be described in detail with reference to the drawings.

### <Configuration>

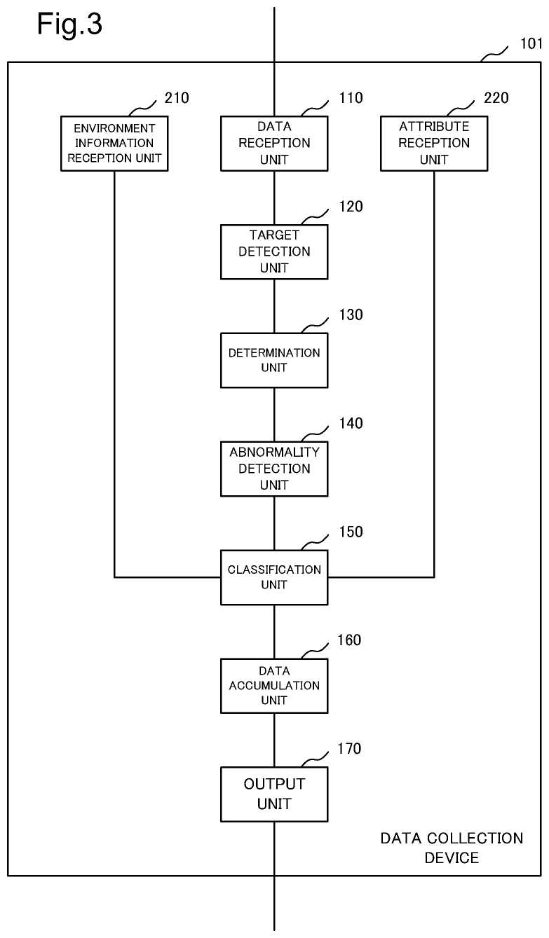

FIG. 3 is a block diagram illustrating an example of a configuration of a data collection device 101 according to the second example embodiment of the present disclosure.

In the example illustrated in FIG. 3, the data collection device 101 includes a data reception unit 110, a target detection unit 120, a determination unit 130, an abnormality detection unit 140, a classification unit 150, and an output unit 170. The data collection device 101 may further include a data accumulation unit 160. The data collection device 101 may further include an environment information reception unit 210. The data collection device 101 may further include an attribute reception unit 220.

### <Data Reception Unit 110>

The data reception unit 110 receives, for example, acoustic data representing a sound observed by a sensor (for example, a microphone) attached to a carriage of the vehicle. The data reception unit 110 may receive the acoustic data directly from the sensor. The data reception unit 110 may receive acoustic data accumulated in a server or the like from the server or the like.

The acoustic data received by the data reception unit 110 may be data in a frequency domain. The acoustic data received by the data reception unit 110 may be time domain data. In that case, the data reception unit 110 converts the received acoustic data into time domain data.

The data reception unit 110 sends the acoustic data to the target detection unit 120.

### <Target Detection Unit 120>

The target detection unit 120 receives acoustic data from the data reception unit 110. Similarly to the target detection unit 120 of the first example embodiment, the target detection unit 120 detects target data points that are data points at which targets are observed in the acoustic data. The target detection unit 120 sends information indicating the detected target data point to the determination unit 130.

The information indicating the target data point is information specifying the target data point in the acoustic data. The information indicating the target data point may be a time at which the data of the target data point is observed. The information indicating the target data point may be a number indicating the order of the data of the target data point in the acoustic data which is time-series information. The information indicating the target data point may be identification information such as a number assigned to data of the target data point in the acoustic data which is time-series information. In the acoustic data, information specifying data observed at a certain time will be referred to as specific information in the following description.

### <Determination Unit 130>

The determination unit 130 receives information indicating the target data point from the target detection unit 120. The determination unit 130 determines the analysis range in the acoustic data based on the target data point, similarly to the determination unit 130 of the first example embodiment. The determination unit 130 sends information indicating the determined analysis range to the abnormality detection unit 140.

When the analysis range is the above-described influence range, the information indicating the analysis range may be the influence start time and the influence end time. In this case, the information indicating the analysis range may be information (that is, specific information) such as a number or an identifier for specifying the data observed at the influence start time and information (that is, specific information) such as a number or an identifier for specifying the data observed at the influence end time.

When the analysis range is a range obtained by excluding the exclusion range from the influence range, the information indicating the analysis range may be the influence start time, the exclusion start time, the exclusion end time, and the influence end time. The information indicating the analysis range may be specific information of data observed at the influence start time, specific information of data observed at the exclusion start time, specific information of data observed at the exclusion end time, and specific information of data observed at the influence end time.

### <Abnormality Detection Unit 140>

The abnormality detection unit 140 receives information indicating the determined analysis range from the determination unit 130. The abnormality detection unit 140 detects an abnormality in the analysis range similarly to the abnormality detection unit 140 of the first example embodiment. The abnormality detection unit 140 sends information of the detected abnormality and information of the analysis range in which the abnormality is detected to the classification unit 150.

The abnormality detection unit 140 may detect a plurality of types of abnormalities in the analysis range. The abnormality detection unit 140 may detect an abnormality pattern in the analysis range and determine that an abnormality is detected when the abnormality pattern is detected. The abnormality pattern may be represented by, for example, a combination of one or more frequency bands including a peak. The abnormality pattern may be represented by, for example, a combination of one or more frequency bands including a peak and a ratio of peak intensity in each frequency band. The abnormality pattern may be different from the above example. The abnormality detection unit 140 may specify an abnormality pattern that best matches the acoustic data in the analysis range among the plurality of abnormality patterns. The abnormality detection unit 140 may calculate a score indicating the degree of match between the acoustic data in the analysis range and each of the plurality of abnormality patterns. The score may be appropriately defined to represent the degree of match.

The type of abnormality may be, for example, bolt breakage of a rail joint, bolt loosening of a rail joint, or the like. In this case, the plurality of abnormality patterns include an abnormality pattern in a case where bolt loosening occurs at a rail joint and an abnormality pattern in a case where bolt breakage occurs at a rail joint. The abnormality detection unit 140 may detect an abnormality using a plurality of abnormality patterns different depending on the weather, the temperature, the type of the vehicle, the weight of the vehicle, and the like. In this case, when at least one of the plurality of abnormality patterns is detected in the analysis range, the abnormality detection unit 140 may determine that an abnormality of a type corresponding to the detected abnormality pattern is detected. The plurality of abnormality patterns are, for example, abnormality patterns obtained in advance by learning.

The abnormality detection unit 140 may detect an abnormality using the above-described detector. The abnormality detection unit 140 may detect an abnormality using a plurality of detectors different depending on the weather, the temperature, the type of the vehicle, the weight of the vehicle, and the like. In this case, when an abnormality is detected by any of the detectors, the abnormality detection unit 140 may determine that an abnormality of a type corresponding to the detector that has detected the abnormality has been detected in the analysis range. The plurality of detectors are, for example, detectors obtained in advance by learning.

The abnormality detection unit 140 may transmit abnormality information (for example, information including information specifying a type of the detected abnormality and a characteristic of the detected abnormality) and information specifying the acoustic data in the analysis range in which the abnormality is detected to the classification unit 150. In the description of the present disclosure, an analysis range in which an abnormality is detected is also referred to as an analysis range in which an abnormality is detected.

### <Classification Unit 150>

The classification unit 150 receives information of the detected abnormality and information of the analysis range in which the abnormality is detected from the abnormality detection unit 140. The abnormality information may include, for example, information indicating the detected abnormality (for example, data included in the analysis range in the observation data) and a characteristic of the detected abnormality (for example, information specifying the type of the detected abnormality).

The classification unit 150 classifies the analysis range in which the abnormality is detected, for example, into at least one of a plurality of classifications. The classifications may each be associated with at least one or more of a plurality of types of abnormalities. The classification may be a type of abnormality. The type of abnormality is not limited to the above example. The classification unit 150 may classify the data of the analysis range in which the abnormality is detected into a classification associated with the type of the detected abnormality. The classification unit 150 may classify the analysis range in which the abnormality pattern is detected into a classification associated with an abnormality pattern that most matches the analysis range. The classification may be determined based on other information. The classification based on other information will be described later as a modification.

The classification unit 150 stores the information of the analysis range in which the abnormality is detected and the information of the classification into which the analysis range is classified in the data accumulation unit 160.

The classification unit 150 may assign the urgency corresponding to the classification to the information of the analysis range in which the abnormality is detected. For example, the classification unit 150 assigns an urgency indicating higher urgency than the urgency assigned to the information of the analysis range classified as bolt loosening and in which the abnormality is detected to the information of the analysis range classified as bolt breakage and in which the abnormality is detected.

### <Operation>

Next, an operation of the data collection device 101 according to the second example embodiment of the present disclosure will be described in detail with reference to the drawings.

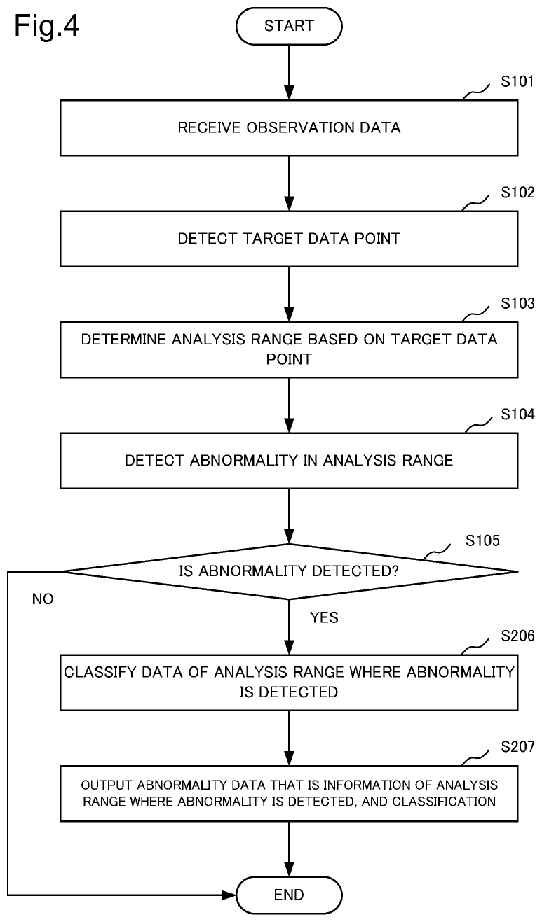

FIG. 4 is a flowchart illustrating an example of the operation of the data collection device 101 according to the second example embodiment of the present disclosure.

In the example illustrated in FIG. 4, the data reception unit 110 receives observation data (step S101). Next, the target detection unit 120 detects a target data point in the observation data (step S102). Next, the determination unit 130 determines an analysis range based on the target data points (step S103). The abnormality detection unit 140 detects an abnormality in the analysis range (step S104). When no abnormality is detected (NO in step S105), the data collection device 101 ends the operation illustrated in FIG. 4.

When an abnormality is detected (YES in step S105), the classification unit 150 classifies the data of the analysis range in which the abnormality is detected (step S206). After step S206, the classification unit 150 may store the abnormality data, which is the information of the analysis range in which the abnormality is detected, and the classification of the abnormality data in the data accumulation unit 160. After step S206, the classification unit 150 may send the abnormality data, which is the information of the analysis range in which the abnormality is detected, and the classification of the abnormality data to the output unit 170. Then, the output unit 170 outputs the abnormality data that is the information of the analysis range in which the abnormality is detected and the classification of the abnormality data (step S207).

### <Effects>

The present example embodiment has the same effect as the effect of the first example embodiment. The reason is the same as the reason why the effect of the first example embodiment occurs.

### First Modification of Second Example Embodiment

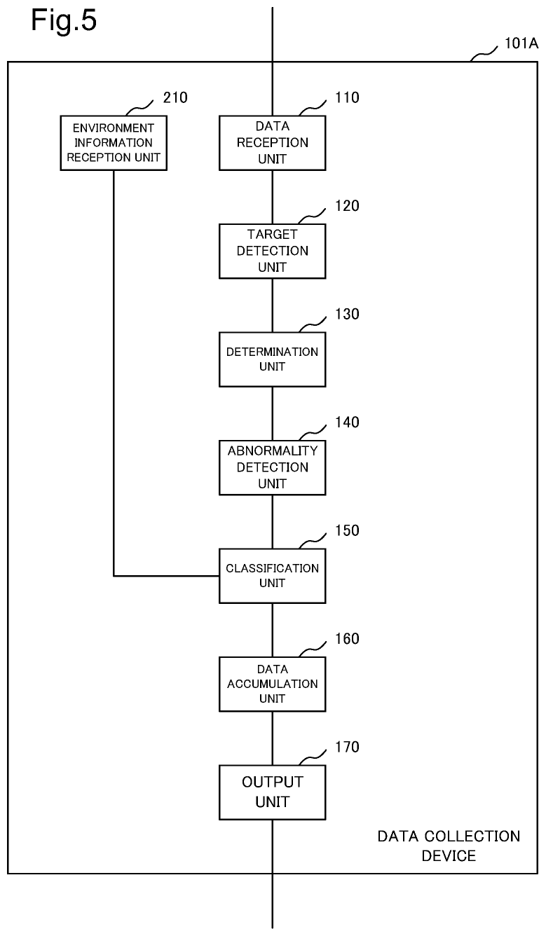

FIG. 5 is a block diagram illustrating an example of a configuration of a data collection device 101A according to a first modification of the second example embodiment. Hereinafter, differences of the data collection device 101A of the present modification from the data collection device 101 of the second example embodiment will be described. Except for the differences described below, the data collection device 101A of the present modification has the same functions as those of the data collection device 101 of the second example embodiment, and operates in a similar manner. In the example illustrated in FIG. 5, the data collection device 101A of the present modification includes an environment information reception unit 210 in addition to all the components of the data collection device 101 of the second example embodiment.

### <Environment Information Reception Unit 210>

The environment information reception unit 210 receives environment information from another device such as a server that stores information at the time of observation. The environment information is, for example, a date and time at the time of observation, a temperature at the observation location, weather, and the like. The environment information is not limited to these examples. The environment information may not include some or all of these.

The environment information reception unit 210 sends the received environment information to the classification unit 150.

### <Classification Unit 150>

The classification unit 150 according to the present example embodiment receives environment information from the environment information reception unit 210. The classification unit 150 classifies the analysis range in which the abnormality is detected into any of the classifications based on the environment information. The classification based on the environment information is, for example, a classification determined based on at least one of the month, the season, the temperature, and the weather at the time of observation.

### Second Modification of Second Example Embodiment

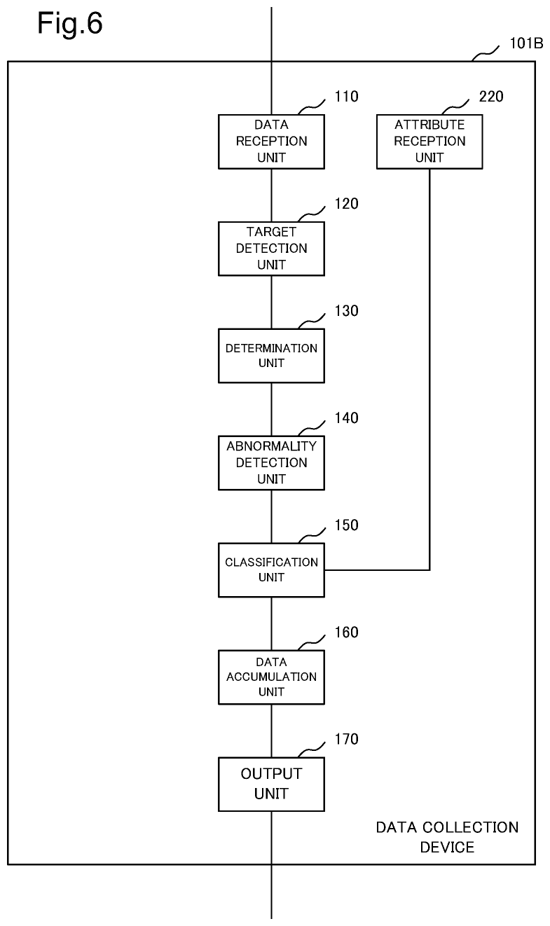

FIG. 6 is a block diagram illustrating an example of a configuration of a data collection device 101B according to a second modification of the second example embodiment. Hereinafter, differences of the data collection device 101B of the present modification from the data collection device 101 of the second example embodiment will be described. Except for the differences described below, the data collection device 101B of the present modification has the same functions as those of the data collection device 101 of the second example embodiment and operates in a similar manner. In the example illustrated in FIG. 6, the data collection device 101B of the present modification includes an attribute reception unit 220 in addition to all the components of the data collection device 101 of the second example embodiment.

### <Attribute Reception Unit 220>

The attribute reception unit 220 receives attribute information from another device such as a server that stores information at the time of observation. The attribute information is a vehicle type, a vehicle weight, track information (for example, the degree of deterioration of the rail, the time elapsed after the rail is laid, and the like), and the like. The degree of deterioration of the rail may be a section according to the frequency at which the vehicle passes through the rail. The degree of deterioration of the rail may be a degree of deterioration determined visually. The attribute information is not limited to these examples. The attribute information may not include some or all of them.

The attribute reception unit 220 sends the received environment information to the classification unit 150.

### <Classification Unit 150>

The classification unit 150 according to the present example embodiment receives the attribute information from the attribute reception unit 220. The classification unit 150 classifies the analysis range in which the abnormality is detected into one of classifications based on the attribute information. The classification based on the attribute information is, for example, a classification determined based on at least one of a vehicle type, a weight category including the vehicle weight, and a track state category including the track information at the time of observation. The weight category is a predetermined weight range of the vehicle. The classification of the track state is, for example, a predetermined range of time elapsed after the rail is laid. The classification of the track state may be a degree of deterioration of the rail.

### Third Modification of Second Example Embodiment

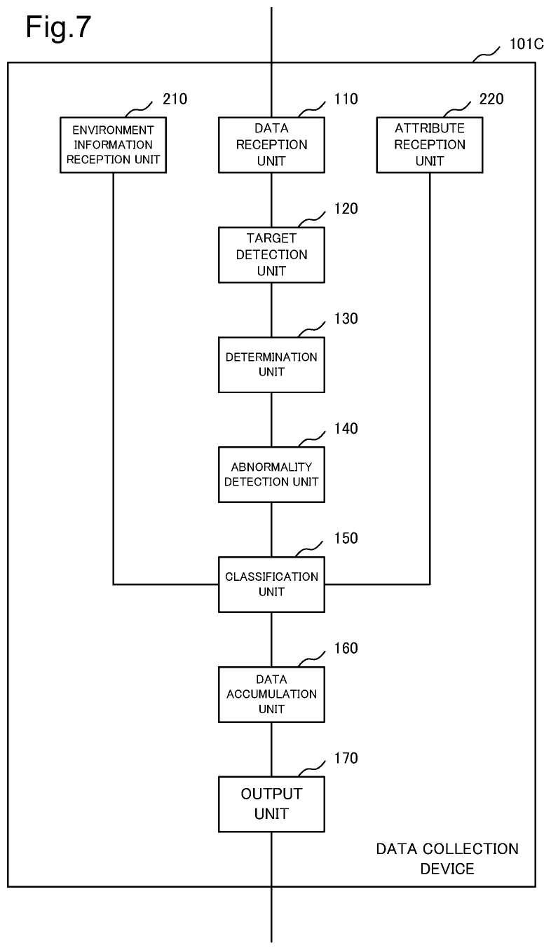

FIG. 7 is a block diagram illustrating an example of a configuration of a data collection device 101C according to a third modification of the second example embodiment. Hereinafter, differences of the data collection device 101C of the present modification from the data collection device 101 of the second example embodiment will be described. Except for the differences described below, the data collection device 101C of the present modification has the same functions as those of the data collection device 101 of the second example embodiment and operates in a similar manner. In the example illustrated in FIG. 7, the data collection device 101B of the present modification includes an environment information reception unit 210 and an attribute reception unit 220 in addition to all the components of the data collection device 101 of the second example embodiment. The environment information reception unit 210 of the present modification is the same as the environment information reception unit 210 of the first modification of the second example embodiment. The attribute reception unit 220 of the present modification is the same as the attribute reception unit 220 of the second modification of the second example embodiment.

### <Classification Unit 150>

The classification unit 150 according to the present example embodiment receives environment information from the environment information reception unit 210. The classification unit 150 according to the present example embodiment further receives attribute information from the attribute reception unit 220. The classification unit 150 classifies the analysis range in which the abnormality is detected into one of classifications based on at least one of environment information and attribute information.

### Fourth Modification of Second Example Embodiment

A fourth modification of the second example embodiment is the same as the second example embodiment except for differences described below.

The data collection device 101 may not include the classification unit 150. In this case, the classification unit 150 sends the information of the analysis range in which the abnormality is detected and the information of the classification in which the analysis range is classified to the output unit 170. The output unit 170 receives the information of the analysis range in which the abnormality is detected and the information of the classification into which the analysis range is classified from the classification unit 150. The data collection device 101 of the present modification is the same as the data collection device 101 of the second example embodiment in other points.

The present modification can also be applied to each of the first to third modifications of the second example embodiment.

### Fifth Modification of Second Example Embodiment

### <Configuration>

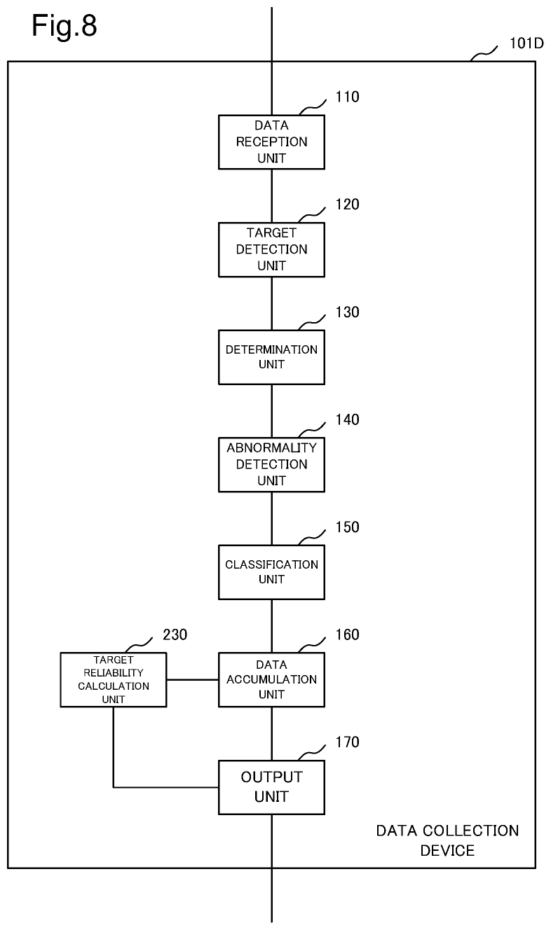

FIG. 8 is a block diagram illustrating an example of a configuration of a data collection device 101D according to a fifth modification of the second example embodiment of the present disclosure. In the example illustrated in FIG. 8, the data collection device 101D of the present modification includes a target reliability calculation unit 230 in addition to all the components of the data collection device 101 of the second example embodiment. The data collection device 101D of the present modification has the same function as the function of the data collection device 101 of the second example embodiment except for the differences described below, and operates similarly to the operation of the data collection device 101 of the second example embodiment. The data collection device 101D of the present modification may not include the classification unit 150. The present modification can also be applied to the first to third modifications.

In the present modification, an identifier (hereinafter, a joint identifier) is given to each of the rail joints. In the present modification, a plurality of sets of acoustic data obtained by a plurality of times of observation on the same line are input to the data collection device 101D.

### <Data Reception Unit 110>

In addition to the acoustic data, the data reception unit 110 receives data associating the target data point with the rail joint. The data associating the target data point with the rail joint is, for example, data specifying the time when the vehicle passes through the joint at the time of observation. The data specifying the time when the vehicle passes through the joint at the time of observation may be, for example, a combination of the joint identifier and the time when the vehicle passes through the joint indicated by the joint identifier. The data specifying the time when the vehicle passes through the joint at the time of observation may be data including a plurality of combinations of the position of the vehicle and the time when the vehicle is present at the position at the time of observation. In this case, for example, the data reception unit 110 may calculate the time when the vehicle passes through the position of the rail joint on the assumption that the vehicle travels at a constant speed between two adjacent positions on the track from a plurality of combinations of the position of the vehicle and the time when the vehicle is present at the position.

### <Abnormality Detection Unit 140>

The abnormality detection unit 140 further generates, for each rail joint (that is, for each detected target data point), a combination of information specifying the rail joint and information indicating whether an abnormality has been detected. Specifically, in addition to detecting an abnormality for each analysis range detected in the acoustic data, the abnormality detection unit 140 specifies a rail joint from which data of a target data point based on the analysis range is obtained. For example, the abnormality detection unit 140 specifies a rail joint through which the vehicle has passed at the time closest to the time at which the data of the target data point based on the analysis range is observed as the rail joint from which the data of the target data point based on the analysis range is obtained. The abnormality detection unit 140 may specify the target data point based on the analysis range as a rail joint from which the data is obtained by another method.

In addition to the information of the analysis range in which the abnormality is detected, the abnormality detection unit 140 stores, in the data accumulation unit 160, the information specifying the rail joint and the information indicating whether the abnormality is detected for each target data point. As described above, the information of the analysis range in which the abnormality is detected is also referred to as abnormality data.

### <Data Accumulation Unit 160>

The data accumulation unit 160 stores information (that is, abnormality data) of the analysis range in which the abnormality is detected, and a combination (hereinafter, also referred to as a result of abnormality detection in the analysis range) of information specifying the rail joint and information indicating whether the abnormality is detected in the analysis range for each target data point. In the present description, the result of abnormality detection in the analysis range is also simply referred to as a result of abnormality detection. As described above, in the present modification, a plurality of sets of acoustic data obtained by a plurality of times of observation on the same line are input to the data collection device 101D. As a result, the data accumulation unit 160 stores the information of the analysis range in which the abnormality is detected and which is obtained from the plurality of sets of acoustic data, and the information indicating whether the abnormality is detected for each rail joint. Then, the data accumulation unit 160 stores information indicating whether an abnormality has been detected in the analysis range of the same rail joint for each of the plurality of sets of acoustic data. When an abnormality is detected in the analysis range, the data accumulation unit 160 stores information of the analysis range in which the abnormality is detected.

### <Target Reliability Calculation Unit 230>

The target reliability calculation unit 230 reads, for each target data point, information specifying a rail joint and information indicating whether an abnormality has been detected in the analysis range, which are stored in the data accumulation unit 160.

The target reliability calculation unit 230 calculates a ratio at which an abnormality is detected in the analysis range for each joint where an abnormality is detected at least once in the analysis range from a combination of information specifying the rail joint and information indicating whether an abnormality is detected in the analysis range. Then, the target reliability calculation unit 230 calculates the target reliability based on the ratio at which the abnormality is detected for each joint. The target reliability is, for example, a value indicating how reliable the data of the analysis range in which the abnormality is detected is as the data observed in the joint where the abnormality occurs. In this example, it is assumed that the probability that an abnormality is detected in the data of the analysis range in the joint is higher as the possibility that an abnormality occurs in the joint is higher. The target reliability calculation unit 230 may set a ratio at which an abnormality is detected as the target reliability. The target reliability calculation unit 230 may calculate the target reliability according to an equation representing the relationship between the ratio at which the abnormality is detected and the target reliability.

The target reliability calculation unit 230 assigns the target reliability calculated for the joint where the abnormality data is observed to the abnormality data stored in the data accumulation unit 160. In other words, the target reliability calculation unit 230 stores the target reliability for each joint in the data accumulation unit 160, and associates the target reliability calculated for the joint where the abnormality data is observed with the abnormality data stored in the data accumulation unit 160.

The target reliability calculation unit 230 may send the target reliability for each joint to the output unit 170.

### <Output Unit 170>

The output unit 170 may receive the target reliability for each joint from the target reliability calculation unit 230. The output unit 170 may output the target reliability for each joint received from the target reliability calculation unit 230.

The output unit 170 may read the abnormality data to which the target reliability is assigned from the data accumulation unit 160 and output the read abnormality data.

### <Operation>

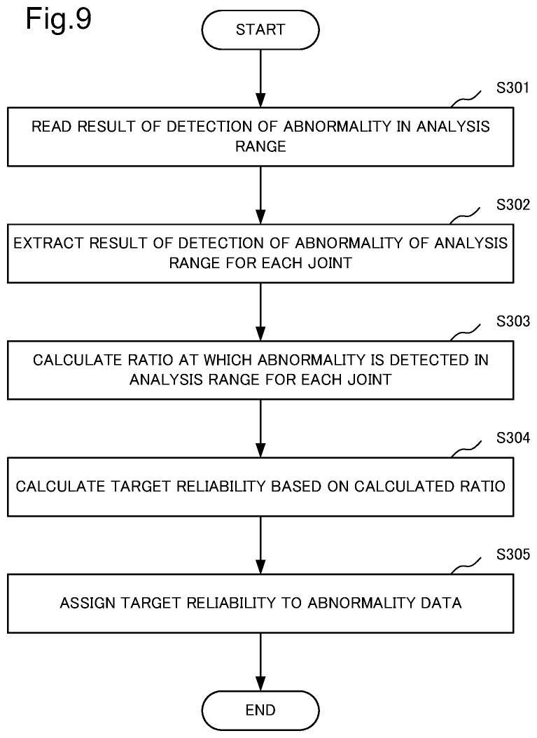

FIG. 9 is a flowchart illustrating an example of the operation of providing the target reliability of the data collection device 101D according to the fifth modification of the second example embodiment of the present disclosure. At the start of the operation shown in FIG. 9, the result of abnormality detection in the analysis range based on the target data points detected from the plurality of sets of acoustic data is stored in the data accumulation unit 160.

In the example illustrated in FIG. 9, first, the target reliability calculation unit 230 reads the result of abnormality detection in the analysis range (step S301). As described above, the result of abnormality detection in the analysis range is a combination of the information specifying the rail joint and the information indicating whether the abnormality is detected in the analysis range for each target data point. The target reliability calculation unit 230 extracts the result of abnormality detection in the analysis range for each joint from the read result of abnormality detection in the analysis range (step S302). In step S302, the target reliability calculation unit 230 extracts, for example, the number of times of detection of the target data point and the number of times of detection of the abnormality in the analysis range based on the target data point for each joint as a result of abnormality detection in the analysis range for each joint.

Next, the target reliability calculation unit 230 calculates a ratio (that is, the rate at which abnormality is detected) at which an abnormality is detected in the analysis range for each joint (step S303). The target reliability calculation unit 230 calculates the target reliability for each rail joint based on the calculated ratio (step S304). The target reliability calculation unit 230 assigns the target reliability to the abnormality data stored in the data accumulation unit 160 (step S305). Specifically, the target reliability calculation unit 230 assigns the target reliability of the joint where the data of the analysis range in which the abnormality is detected, which is the abnormality data, is obtained to the abnormality data stored in the data accumulation unit 160.

Then, the data collection device 101D ends the operation illustrated in FIG. 9.

### Sixth Modification of Second Example Embodiment

The configuration of the data collection device 101D according to a sixth modification of the second example embodiment of the present disclosure is the same as the configuration of the data collection device 101D according to the fifth modification of the second example embodiment of the present disclosure. The data collection device 101D of the present modification has the same function as the function of the data collection device 101D according to the fifth modification of the second example embodiment except for the difference described below, and operates similarly to the operation of the data collection device 101D according to the fifth modification of the second example embodiment. The present modification can also be applied to the first to third modifications.

In the present modification, as in the fifth modification, an identifier (hereinafter, a Joint identifier) is given to each of the rail joints. In the present modification, a plurality of sets of acoustic data obtained by a plurality of times of observation on the same line are input to the data collection device 101D.

<Data reception unit 110>

The data reception unit 110 further receives, for each rail joint, information (hereinafter, referred to as abnormality actual measurement information) indicating whether an abnormality exists, which is visually confirmed, for example. The data reception unit 110 sends the abnormality actual measurement information to the classification unit 150 via, for example, the target detection unit 120, the determination unit 130, and the abnormality detection unit 140. The classification unit 150 receives the abnormality actual measurement information and stores the received abnormality actual measurement information in the data accumulation unit 160. The data reception unit 110 may directly store the received abnormality actual measurement information in the data accumulation unit 160. The data reception unit 110 may transmit the received abnormality actual measurement information to the target reliability calculation unit 230. In FIG. 8, a line connecting the data reception unit 110 and the data accumulation unit 160 and a line connecting the data reception unit 110 and the target reliability calculation unit 230 are omitted for simplification of the drawing.

### <Target Reliability Calculation Unit 230>

The target reliability calculation unit 230 reads the abnormality actual measurement information from the data accumulation unit 160. The target reliability calculation unit 230 may receive the abnormality actual measurement data from the data reception unit 110.

The target reliability calculation unit 230 calculates the target reliability of the joint where the abnormality exists in the abnormality actual measurement information in the same manner as the target reliability calculation unit 230 of the fifth modification of the second example embodiment calculates the target reliability. The target reliability calculation unit 230 sets the target reliability of the joint where no abnormality exists to 0 in the abnormality actual measurement information.

### Seventh Modification of Second Example Embodiment

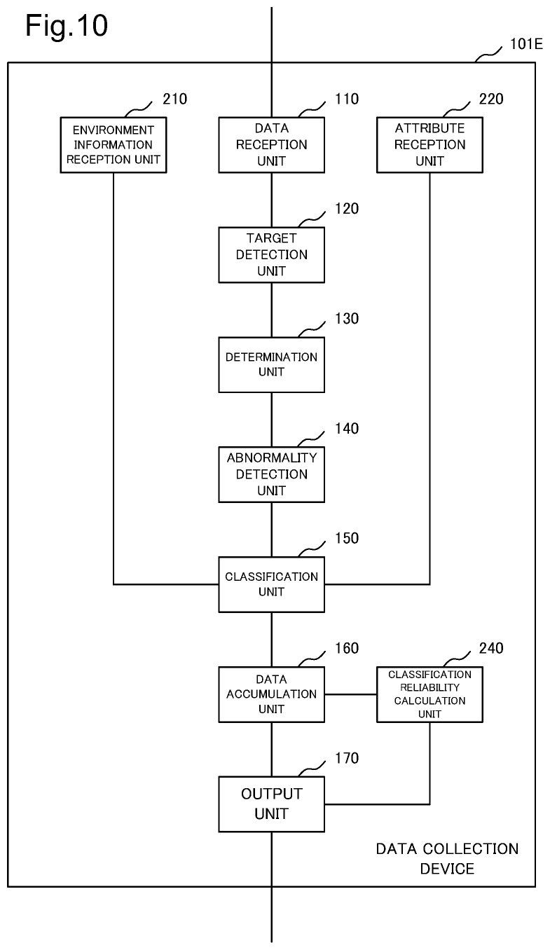

FIG. 10 is a block diagram illustrating an example of a configuration of a data collection device 101E according to a seventh modification of the second example embodiment of the present disclosure. In the example illustrated in FIG. 10, the data collection device 101E includes an environment information reception unit 210, an attribute reception unit 220, and a classification reliability calculation unit 240 in addition to all the components of the data collection device 101 according to the second example embodiment. The data collection device 101E may not include one of the environment information reception unit 210 and the attribute reception unit 220. The present modification can also be applied to the fifth and sixth modifications.

### <Data Reception Unit 110>

The data reception unit 110 of the present modification has the same function as the data reception unit 110 of the fifth modification, and performs the same operation as the operation of the data reception unit 110 of the fifth modification. That is, the data reception unit 110 receives, in addition to the acoustic data, data associating the target data point with the rail joint. The data associating the target data point with the rail joint is, for example, data specifying the time when the vehicle passes through the joint at the time of observation. The data specifying the time when the vehicle passes through the joint at the time of observation may be, for example, a combination of the joint identifier and the time when the vehicle passes through the joint indicated by the joint identifier. The data specifying the time when the vehicle passes through the joint at the time of observation may be data including a plurality of combinations of the position of the vehicle and the time when the vehicle is present at the position at the time of observation. In this case, for example, the data reception unit 110 may calculate the time when the vehicle passes through the position of the rail joint on the assumption that the vehicle travels at a constant speed between two adjacent positions on the track from a plurality of combinations of the position of the vehicle and the time when the vehicle is present at the position.

Similarly to the data reception unit 110 of the sixth modification, the data reception unit 110 further receives, for each rail joint, information (that is, the abnormality actual measurement information) indicating whether an abnormality exists, which is visually confirmed, for example. The data reception unit 110 sends the abnormality actual measurement information to the classification unit 150 via, for example, the target detection unit 120, the determination unit 130, and the abnormality detection unit 140. The classification unit 150 receives the abnormality actual measurement information and stores the received abnormality actual measurement information in the data accumulation unit 160. The data reception unit 110 may directly store the received abnormality actual measurement information in the data accumulation unit 160. The data reception unit 110 may transmit the received abnormality actual measurement information to the classification reliability calculation unit 240. In FIG. 10, a line connecting the data reception unit 110 and the data accumulation unit 160 and a line connecting the data reception unit 110 and the classification reliability calculation unit 240 are omitted for simplification of the drawing.

### <Abnormality Detection Unit 140>

The abnormality detection unit 140 of the present modification has the same function as the abnormality detection unit 140 of the fifth modification and performs the same operation as the operation of the abnormality detection unit 140 of the fifth modification.

### <Data Accumulation Unit 160>

The data accumulation unit 160 of the present modification is the same as the data accumulation unit 160 of the fifth modification. The data accumulation unit 160 stores information (that is, abnormality data) of the analysis range in which the abnormality is detected, and a combination of information specifying the rail joint and information indicating whether the abnormality is detected in the analysis range for each target data point. As described above, a combination of information indicating whether an abnormality is detected in the analysis range is also referred to as a result of abnormality detection in the analysis range and a result of abnormality detection. In the present modification, a plurality of sets of acoustic data obtained by a plurality of times of observation on the same line are input to the data collection device 101D. As a result, the data accumulation unit 160 stores the information of the analysis range in which the abnormality is detected and which is obtained from the plurality of sets of acoustic data, and the information indicating whether the abnormality is detected for each rail joint. Then, the data accumulation unit 160 stores information indicating whether an abnormality has been detected in the analysis range of the same rail joint for each of the plurality of sets of acoustic data. When an abnormality is detected in the analysis range, the data accumulation unit 160 stores information of the analysis range in which the abnormality is detected.

### <Environment Information Reception Unit 210>

The environment information reception unit 210 of the present modification is the same as the environment information reception unit 210 of the first modification. In other words, the environment information reception unit 210 of the present modification has the same function as the function of the environment information reception unit 210 of the first modification, and performs the same operation as the operation of the environment information reception unit 210 of the first modification.

### <Attribute Reception Unit 220>

The attribute reception unit 220 of the present modification is the same as the attribute reception unit 220 of the second modification. In other words, the attribute reception unit 220 of the present modification has the same function as the function of the attribute reception unit 220 of the second modification, and performs the same operation as the operation of the attribute reception unit 220 of the first modification.

### <Classification Unit 150>

In a case where a data collection device 101F includes the environment information reception unit 210, the classification unit 150 has the same function as the function of the classification unit 150 of the first modification, and is configured to perform the same operation as the operation of the classification unit 150 of the first modification. In a case where the data collection device 101F includes the attribute reception unit 220, the classification unit 150 has the same function as the function of the classification unit 150 of the second modification, and is configured to perform the same operation as the operation of the classification unit 150 of the second modification.

The classification of the present modification is a classification based on at least one of environment information and attribute information. In a case where the data collection device 101F does not include the environment information reception unit 210, the classification of the present modification may be a classification based on the attribute information. In a case where the data collection device 101F does not include the attribute reception unit 220, the classification of the present modification may be a classification based on the environment information.

In the present modification, the classification unit 150 classifies each of the detected target data points into any classification. The classification unit 150 stores information (hereinafter, referred to as a classification result) indicating the classification into which the target data point is classified for each target data point in the data accumulation unit 160.

### <Data Accumulation Unit 160>

The data accumulation unit 160 of the present modification functions similarly to the data accumulation unit 160 of the fifth modification. The data accumulation unit 160 of the present modification further stores a classification result.

### <Classification Reliability Calculation Unit 240>

The classification reliability calculation unit 240 reads the abnormality actual measurement information stored in the data accumulation unit 160. The classification reliability calculation unit 240 may receive the abnormality actual measurement information from the data reception unit 110.

The classification reliability calculation unit 240 reads, for each target data point, information specifying a rail joint and information indicating whether an abnormality has been detected in the analysis range, which are stored in the data accumulation unit 160. The classification reliability calculation unit 240 further reads the classification result from the data accumulation unit 160.

The classification reliability calculation unit 240 calculates a ratio at which an abnormality is detected in the analysis range for each joint where an abnormality is present in the abnormality actual measurement information from a combination of information specifying a rail joint and information indicating whether an abnormality is detected in the analysis range. Then, the classification reliability calculation unit 240 calculates the classification reliability based on the rate at which the abnormality is detected for each classification in which the joint where the abnormality exists is classified in the abnormality actual measurement information. The classification reliability is, for example, a value representing a degree of possibility that an abnormality is detected in a situation corresponding to the classification when an abnormality occurs in the joint. For example, the classification reliability calculation unit 240 may set a higher classification reliability as there is a higher possibility that an abnormality is detected from an analysis range observed in a joint where an abnormality has occurred. The classification reliability calculation unit 240 may set a ratio at which an abnormality is detected for each classification as the classification reliability. The classification reliability calculation unit 240 may calculate the classification reliability according to a formula representing a relationship between a rate at which an abnormality is detected and the classification reliability.

The classification reliability calculation unit 240 assigns the classification reliability calculated for the classification based on at least one of the environment information and the attribute when the abnormality data is observed to the abnormality data stored in the data accumulation unit 160. In other words, the classification reliability calculation unit 240 stores the classification reliability for each classification in the data accumulation unit 160. Then, the classification reliability calculation unit 240 associates the target reliability calculated for the classification based on at least one of the environment information and the attribute when the abnormality data is observed with the abnormality data stored in the data accumulation unit 160.

The classification reliability calculation unit 240 may transmit the classification reliability for each classification to the output unit 170.

### <Output Unit 170>

The output unit 170 may receive the target reliability for each classification from the classification reliability calculation unit 240. The output unit 170 may output the target reliability for each classification received from the classification reliability calculation unit 240.

The output unit 170 may read the abnormality data to which the classification reliability is assigned from the data accumulation unit 160 and output the read abnormality data.

### <Operation>

Next, an operation of the data collection device 101E according to the seventh example embodiment of the present disclosure will be described in detail with reference to the drawings.

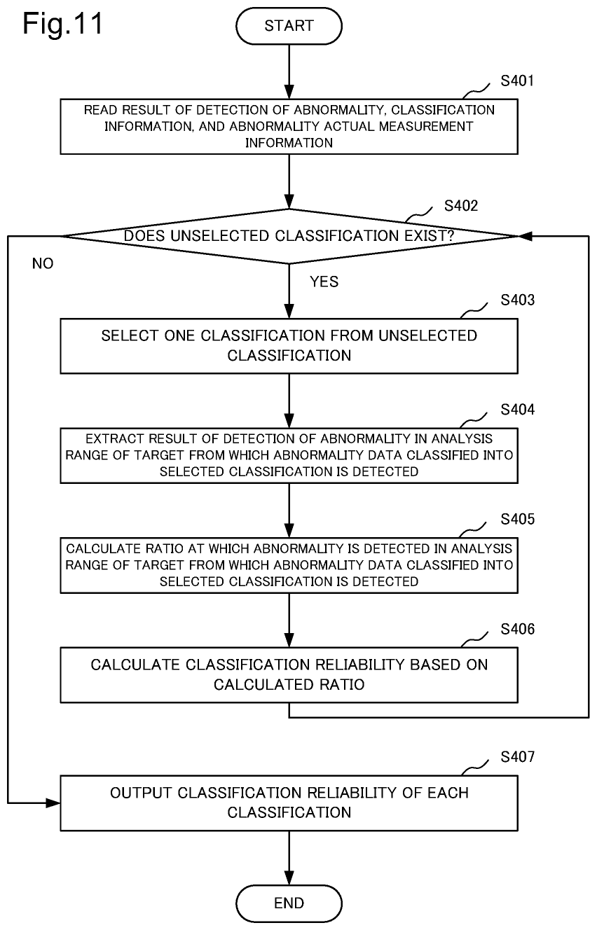

FIG. 11 is a flowchart illustrating an example of the operation of the data collection device 101E according to the seventh example embodiment of the present disclosure. At the start of the operation illustrated in FIG. 11, classification information is stored in the data accumulation unit 160. Results of abnormality detection in an analysis range based on target data points detected from a plurality of sets of acoustic data are stored in the data accumulation unit 160. Abnormality actual measurement information is stored in the data accumulation unit 160.

In the example illustrated in FIG. 11, the classification reliability calculation unit 240 reads a result of abnormality detection, classification information, and abnormality actual measurement information from the data accumulation unit 160 (step S401). At the time when the operation of step S401 ends, the classification is not selected.

When there is an unselected classification (YES in step S402), the classification reliability calculation unit 240 selects one classification from the unselected classifications (step S403). The classification reliability calculation unit 240 extracts a result of abnormality detection in the analysis range of the target (that is, the rail joint) in which the abnormality data classified into the selected classification is detected (step S404). The classification reliability calculation unit 240 calculates a ratio at which an abnormality is detected in an analysis range of a target (that is, the rail joint) in which abnormality data classified into the selected classification is detected (step S405). The classification reliability calculation unit 240 calculates the classification reliability for each classification based on the calculated ratio (step S406). The operation of the data collection device 101E returns to step S402 after step S406.

When there is no unselected classification (NO in step S402), the output unit 170 outputs the classification reliability of each classification (step S407). In step S407, the output unit 170 may output the abnormality data to which the classification reliability is assigned.

### Eighth Modification of Second Example Embodiment

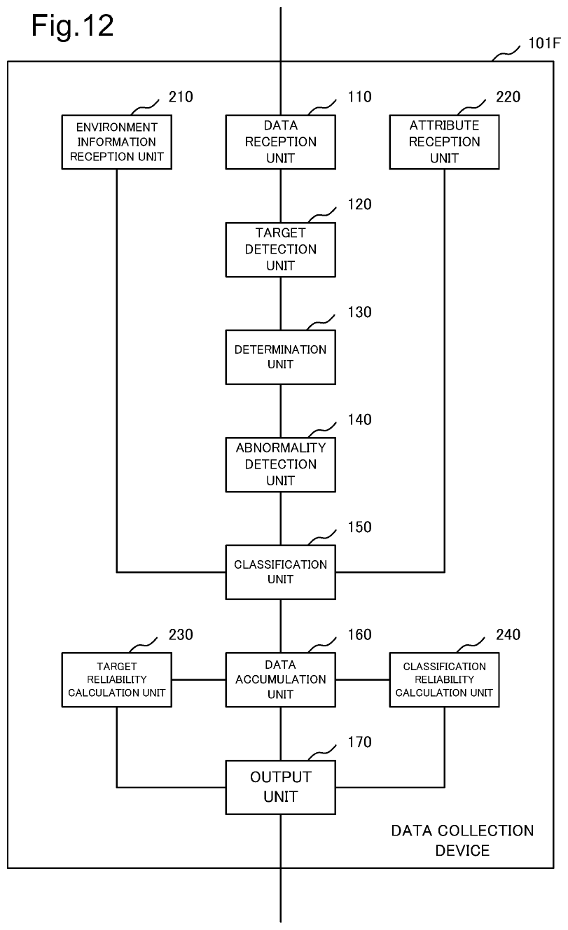

FIG. 12 is a block diagram illustrating an example of a configuration of a data collection device 101F according to an eighth modification of the second example embodiment of the present disclosure. In the example illustrated in FIG. 12, the data collection device 101F of the present modification includes a target reliability calculation unit 230 in addition to all the components of the data collection device 101F according to the seventh modification. The data collection device 101F of the present modification has the same function as the function of the data collection device 101D of the fifth or sixth modification in addition to the function of the data collection device 101E of the seventh modification. In addition to the operation of the data collection device 101E of the seventh modification, the data collection device 101F of the present modification performs the same operation as the operation of the data collection device 101D of the fifth or sixth modification.

### Other Example Embodiments

Each of the data collection devices according to the example embodiments of the present disclosure can be achieved by a computer including a processor that executes a program loaded in a memory. Each of the data collection devices according to the example embodiments of the present disclosure can also be achieved by dedicated hardware. Each of the data collection devices according to the example embodiments of the present disclosure can also be achieved by a combination of the above-described computer and dedicated hardware.

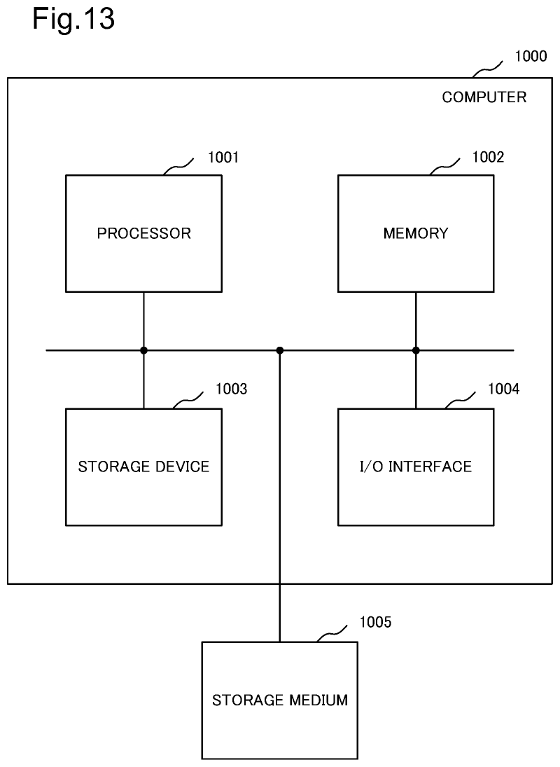

FIG. 13 is a diagram illustrating an example of a hardware configuration of a computer 1000 that can implement each of the data collection devices according to the example embodiment of the present disclosure. In the example of FIG. 13, the computer 1000 includes a processor 1001, a memory 1002, a storage device 1003, and an input/output (I/O) interface 1004. The computer 1000 can access a storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium. The storage device 1003 may be the storage medium 1005. The processor 1001 can read and write data and programs from and in the memory 1002 and the storage device 1003. The processor 1001 may access other devices, for example, a server, via the I/O interface 1004. The processor 1001 may access the storage medium 1005. The storage medium 1005 stores a program for operating the computer 1000 as the data collection device according to the example embodiment of the present disclosure.

The processor 1001 loads a program, which is stored in the storage medium 1005 and causes the computer 1000 to operate as the data collection device according to the example embodiments of the present disclosure, into the memory 1002. Then, when the processor 1001 executes the program loaded in the memory 1002, the computer 1000 operates as a data collection device according to the example embodiments of the present disclosure.

The data reception unit 110, the target detection unit 120, the determination unit 130, the abnormality detection unit 140, the classification unit 150, and the output unit 170 can be achieved by, for example, the processor 1001 that executes a program loaded in the memory 1002. The environment information reception unit 210, the attribute reception unit 220, the target reliability calculation unit 230, and the classification reliability calculation unit 240 can be achieved by, for example, the processor 1001 that executes a program loaded in the memory 1002. The data accumulation unit 160 can be achieved by the memory 1002 included in the computer 1000 or the storage device 1003 such as a hard disk device. Some or all of the data reception unit 110, the target detection unit 120, the determination unit 130, the abnormality detection unit 140, the classification unit 150, the data accumulation unit 160, and the output unit 170 can be achieved by a dedicated circuit that achieves the functions of the units. Some or all of the environment information reception unit 210, the attribute reception unit 220, the target reliability calculation unit 230, and the classification reliability calculation unit 240 can also be implemented by a dedicated circuit that implements the functions of the units.

Some or all of the above example embodiments may be described as the following supplementary notes, but are not limited to the following.

### (Supplementary Note 1)

A data collection device including:
target detection means for detecting a target data point which is a data point at which a target is observed in acoustic data obtained by observation of the target;
determination means for determining an analysis range in the acoustic data based on the target data point;
abnormality detection means for detecting an abnormality in the analysis range; and
output means for outputting information of the analysis range in which the abnormality is detected.

### (Supplementary Note 2)

The data collection device according to Supplementary Note 1, in which
the determination means excludes an exclusion range that is shorter than the analysis range and includes the target data point from the analysis range.

### (Supplementary Note 3)

The data collection device according to Supplementary Note 1 or 2, in which
the output means stores information of the analysis range in an abnormality database when the abnormality is detected.

### (Supplementary Note 4)

The data collection device according to Supplementary Note 3, further including:
classification means for classifying the information of the analysis range based on a type of the detected abnormality.

### (Supplementary Note 5)

The data collection device according to Supplementary Note 4, further including:
environment information reception means for receiving environment information of observation of the target, in which
the classification means classifies the information of the analysis range based on the environment information.

### (Supplementary Note 6)

The data collection device according to Supplementary Note 4 or 5, further including:
attribute reception means for receiving an attribute of the target, in which
the classification means classifies the information of the analysis range based on the attribute.

### (Supplementary Note 7)

The data collection device according to any one of Supplementary Notes 4 to 6, further including:
classification reliability calculation means for calculating a classification reliability for each classification into which the information of the analysis range is classified, based on a rate at which an abnormality is detected in the target in which the abnormality is detected.

### (Supplementary Note 8)

The data collection device according to any one of Supplementary Notes 1 to 7, further including:
target reliability calculation means for calculating a target reliability of information of the abnormality of the target based on a rate at which the abnormality is detected in a plurality of measurements on the target at which the abnormality is detected.

### (Supplementary Note 9)

The data collection device according to any one of Supplementary Notes 1 to 8, in which
the abnormality detection means determines an urgency of an abnormality occurring in the target based on a type of the detected abnormality.

### (Supplementary Note 10)

The data collection device according to any one of Supplementary Notes 1 to 9, in which
the target is a rail joint.

### (Supplementary Note 11)

A data collection method including:
detecting a target data point that is a data point at which a target is observed in acoustic data obtained by observation of the target;
determining an analysis range in the acoustic data based on the target data point;
detecting an abnormality in the analysis range; and
outputting information of the analysis range in which the abnormality is detected.

### (Supplementary Note 12)

The data collection method according to Supplementary Note 11, further including:
excluding, from the analysis range, an exclusion range that is shorter than the analysis range and includes the target data point.

### (Supplementary Note 13)

The data collection method according to Supplementary Note 11 or 12, further including:
storing, when the abnormality is detected, information of the analysis range in an abnormality database.

### (Supplementary Note 14)

The data collection method according to Supplementary Note 13, further including:
classifying the information of the analysis range based on a type of the detected abnormality.

### (Supplementary Note 15)

The data collection method according to Supplementary Note 14, further including:
receiving environment information of observation of the target; and
classifying the information of the analysis range based on the environment information.

### (Supplementary Note 16)

The data collection method according to Supplementary Note 14 or 15, further including:
receiving an attribute of the target; and classifying the information of the analysis range based on the attribute.

### (Supplementary Note 17)

The data collection method according to any one of Supplementary Notes 14 to 16, further including:
calculating a classification reliability for each classification into which the information of the analysis range is classified based on a rate at which an abnormality is detected in the target in which the abnormality is detected.

### (Supplementary Note 18)

The data collection method according to any one of Supplementary Notes 11 to 17, further including:
calculating a target reliability of information of the abnormality of the target based on a rate at which the abnormality is detected in a plurality of measurements on the target at which the abnormality is detected.

### (Supplementary Note 19)

The data collection method according to any one of Supplementary Notes 11 to 18, further including:
determining an urgency of an abnormality occurring in the target based on a type of the detected abnormality.

### (Supplementary Note 20)

The data collection method according to any one of Supplementary Notes 11 to 19, in which
the target is a rail joint.

### (Supplementary Note 21)

A storage medium having stored therein a program causing a computer to execute:
detecting a target data point which is a data point at which a target is observed in acoustic data obtained by observation of the target;
determining an analysis range in the acoustic data based on the target data point;
detecting an abnormality in the analysis range; and
outputting information of the analysis range in which the abnormality is detected.

### (Supplementary Note 22)

The storage medium according to Supplementary Note 21, in which
the determining excludes an exclusion range that is shorter than the analysis range and includes the target data point from the analysis range.

### (Supplementary Note 23)

The storage medium according to Supplementary Note 21 or 22, in which
the outputting stores information of the analysis range in an abnormality database when the abnormality is detected.

### (Supplementary Note 24)

The storage medium according to Supplementary Note 23, in which the program further causes a computer to execute:
classifying the information of the analysis range based on a type of the detected abnormality.

### (Supplementary Note 25)

The storage medium according to Supplementary Note 24, in which the program further causes a computer to execute:
receiving environment information of observation of the target, and
the classifying classifies the information of the analysis range based on the environment information.

### (Supplementary Note 26)

The storage medium according to Supplementary Note 24 or 25, in which the program further causes a computer to execute:
receiving an attribute of the target, and
the classifying classifies the information of the analysis range based on the attribute.

### (Supplementary Note 27)

The storage medium according to any one of Supplementary Notes 24 to 26, in which the program further causes a computer to execute:
calculating a classification reliability for each classification into which the information of the analysis range is classified, based on a rate at which an abnormality is detected in the target in which the abnormality is detected.

### (Supplementary Note 28)

The storage medium according to any one of Supplementary Notes 21 to 27, in which the program further causes a computer to execute:
calculating a target reliability of information of the abnormality of the target based on a rate at which the abnormality is detected in a plurality of measurements on the target at which the abnormality is detected.

### (Supplementary Note 29)

The storage medium according to any one of Supplementary Notes 21 to 28, in which
the detecting determines an urgency of an abnormality occurring in the target based on a type of the detected abnormality.

### (Supplementary Note 30)

The storage medium according to any one of Supplementary Notes 21 to 29, in which
the target is a rail joint.

Although the present invention has been described with reference to the example embodiments, the present invention is not limited to the above example embodiments. Various modifications that can be understood by those skilled in the art can be made to the configuration and details of the present invention within the scope of the present invention.

### REFERENCE SIGNS LIST

100 data collection device
101 data collection device
101A data collection device
101B data collection device
101C data collection device
101D data collection device
101E data collection device
101F data collection device
110 data reception unit
120 target detection unit
130 determination unit
140 abnormality detection unit
150 classification unit
160 data accumulation unit
170 output unit
210 environment information reception unit
220 attribute reception unit
230 target reliability calculation unit
240 classification reliability calculation unit
1000 computer
1001 processor
1002 memory
1003 storage device
1004 I/O interface
1005 storage medium

What is claimed is:

1. A data collection device comprising:
at least one memory storing a set of instructions; and
at least one processor configured to execute the set of instructions to:
detect a target data point that is a data point at which a target is observed in acoustic data obtained by observation of the target;
determine an analysis range in the acoustic data based on the target data point;
detect an abnormality in the analysis range; and
output information of the analysis range in which the abnormality is detected.

2. The data collection device according to claim 1, wherein
the at least one processor is further configured to execute the instructions to exclude an exclusion range that is shorter than the analysis range and includes the target data point from the analysis range.

3. The data collection device according to claim 1, wherein
the at least one processor is further configured to execute the instructions to store information of the analysis range in an abnormality database when the abnormality is detected.

4. The data collection device according to claim 3, wherein
the at least one processor is further configured to execute the instructions to classify the information of the analysis range based on a type of the detected abnormality.

5. The data collection device according to claim 4, wherein:
the at least one processor is further configured to execute the instructions to:
receive environment information of observation of the target; and
classify the information of the analysis range based on the environment information.

6. The data collection device according to claim 4, wherein
the at least one processor is further configured to execute the instructions to:
attribute reception means for receiving receive an attribute of the target; and
classify the information of the analysis range based on the attribute.

7. The data collection device according to claim 4, wherein
the at least one processor is further configured to execute the instructions to calculate a classification reliability for each classification into which the information of the analysis range is classified, based on a rate at which an abnormality is detected in the target in which the abnormality is detected.

8. The data collection device according to claim 1, wherein
the at least one processor is further configured to execute the instructions to calculate a target reliability of information of the abnormality of the target based on a rate at which the abnormality is detected in a plurality of measurements on the target at which the abnormality is detected.

9. The data collection device according to claim 1, wherein
the at least one processor is further configured to execute the instructions to determine an urgency of an abnormality occurring in the target based on a type of the detected abnormality.

10. The data collection device according to claim 1, wherein
the target is a rail joint.

11. A data collection method comprising:
detecting a target data point that is a data point at which a target is observed in acoustic data obtained by observation of the target;
determining an analysis range in the acoustic data based on the target data point;
detecting an abnormality in the analysis range; and
outputting information of the analysis range in which the abnormality is detected.

12. The data collection method according to claim 11, further comprising:
excluding, from the analysis range, an exclusion range that is shorter than the analysis range and includes the target data point.

13. The data collection method according to claim 11, further comprising:
storing, when the abnormality is detected, information of the analysis range in an abnormality database.

14. The data collection method according to claim 13, further comprising:
classifying the information of the analysis range based on a type of the detected abnormality.

15. The data collection method according to claim 14, further comprising:
receiving environment information of observation of the target; and
classifying the information of the analysis range based on the environment information.

16. The data collection method according to claim 14, further comprising:
receiving an attribute of the target; and
classifying the information of the analysis range based on the attribute.

17. The data collection method according to claim 14, further comprising:
calculating a classification reliability for each classification into which the information of the analysis range is classified based on a rate at which an abnormality is detected in the target in which the abnormality is detected.

18. The data collection method according to claim 11, further comprising:
calculating a target reliability of information of the abnormality of the target based on a rate at which the abnormality is detected in a plurality of measurements on the target at which the abnormality is detected.

19. The data collection method according to claim 11,
determining an urgency of an abnormality occurring in the target based on a type of the detected abnormality.

20. (canceled)

21. A non-transitory computer readable storage medium having stored therein a program causing a computer to execute:
detecting a target data point which is a data point at which a target is observed in acoustic data obtained by observation of the target;
determining an analysis range in the acoustic data based on the target data point;
detecting an abnormality in the analysis range; and
outputting information of the analysis range in which the abnormality is detected.

22-30. (canceled)
